(19) United States
(12) Patent Application Publication
(10) Pub. No.: US 2008/0178269 A1
(43) Pub. Date: Jul. 24, 2008

(54) APPARATUS AND METHOD FOR PROVIDING SERVICE AUTHENTICATION INFORMATION IN A COMMUNICATION SYSTEM

(75) Inventors: Ki-Back KIM, Seongnam-si (KR); Ji-Cheol Lee, Yongin-si (KR); Jae-Woo Kwon, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/018,535

(22) Filed: Jan. 23, 2008

(30) Foreign Application Priority Data
Jan. 23, 2007 (KR) 7113/2007
Mar. 2, 2007 (KR) 20837/2007

(51) Int. Cl. G06F 7/04

(52) U.S. Cl. 726/4

(57) ABSTRACT

In a communication system, a Mobile Station (MS) transmits a Multicast/Broadcast Service (MCBCS) authentication information transmission request message to an MCBCS server, and receives MCBCS authentication information from the MCBCS server in response to transmission of the MCBCS authentication information transmission request message. The MCBCS authentication information is information that the MCBCS server has derived using MCBCS MS profile information managed by an Authorization, Authentication and Accounting (AAA) server according to the MCBCS authentication information transmission request message, and the MCBCS MS profile information includes a random seed allocated to at least one MCBCS channel serviceable by the MS.

### PRIORITY

This application claims priority under 35 U.S.C. § 119(a) to a Korean Patent Application filed in the Korean Intellectual Property Office on Jan. 23, 2007 and assigned Serial No. 2007-7113, and a Korean Patent Application filed in the Korean Intellectual Property Office on Mar. 2, 2007 and assigned Serial No. 2007-20837, the disclosures of both of which are incorporated herein by reference.

### BACKGROUND OF THE INVENTION

1. Field of the Invention

The present invention relates to an apparatus and method for providing service authentication information in a communication system.

2. Description of the Related Art

The next generation communication systems are being developed to provide various high-speed, high-capacity services to Mobile Stations (MSs). A Mobile Worldwide Interoperability for Microwave Access (Mobile WiMAX) communication system is a typical example of the next generation communication system, and the Mobile WiMAX communication system is a communication system based on, for example, the Institute of Electrical and Electronics Engineers (IEEE) 802.16 standard.

The typical service that the Mobile WiMAX communication system aims to provide is Multicast/Broadcast Service (MCBCS). Generally, the MCBCS is also called MBS. However, for the Mobile WiMAX communication system, though intensive research thereon is being conducted now, nothing has yet been determined on its detailed operation, so nothing has been determined either on the detailed scheme of providing MCBCS authentication information, for example, MCBCS key, during MCBCS provision.

### SUMMARY OF THE INVENTION

An aspect of the present invention is to address at least the problems and/or disadvantages and to provide at least the advantages described below. Accordingly, an aspect of the present invention is to provide an apparatus and method for providing MCBCS authentication information in a communication system.

Another aspect of the present invention is to provide an apparatus and method for providing MCBCS authentication information differentiated for each MS in a communication system.

According to one aspect of the present invention, there is provided an apparatus for providing service authentication information in a communication system. The apparatus includes a Mobile Station (MS) for transmitting a Multicast/Broadcast Service (MCBCS) authentication information transmission request message to an MCBCS server, and receiving MCBCS authentication information from the MCBCS server in response to transmission of the MCBCS authentication information transmission request message. The MCBCS authentication information is information that the MCBCS server has derived using MCBCS MS profile information managed by an Authorization, Authentication and Accounting (AAA) server according to the MCBCS authentication information transmission request message, and the MCBCS MS profile information includes a random seed allocated to at least one MCBCS channel serviceable by the MS.

According to another aspect of the present invention, there is provided an apparatus for providing service authentication information in a communication system. The apparatus includes a Multicast/Broadcast Service (MCBCS) server for receiving an MCBCS authentication information transmission request message from a Mobile Station (MS), performing an MCBCS MS profile information query operation with an Authorization, Authentication and Accounting (AAA) server in response to reception of the MCBCS authentication information transmission request message, deriving MCBCS authentication information for the MS according to the result of the MCBCS MS profile information query operation, and transmitting the derived MCBCS authentication information to the MS. The MCBCS MS profile information includes a random seed allocated to at least one MCBCS channel serviceable by the MS.

According to further another aspect of the present invention, there is provided a method for providing service authentication information by a Mobile Station (MS) in a communication system. The method includes transmitting a Multicast/Broadcast Service (MCBCS) authentication information transmission request message to an MCBCS server; and receiving MCBCS authentication information from the MCBCS server in response to transmission of the MCBCS authentication information transmission request message. The MCBCS authentication information is information that the MCBCS server has derived using MCBCS MS profile information managed by an Authorization, Authentication and Accounting (AAA) server according to the MCBCS authentication information transmission request message, and the MCBCS MS profile information includes a random seed allocated to at least one MCBCS channel serviceable by the MS.

According to yet another aspect of the present invention, there is provided a method for providing service authentication information by a Multicast/Broadcast Service (MCBCS) server in a communication system. The method includes receiving an MCBCS authentication information transmission request message from a Mobile Station (MS); performing an MCBCS MS profile information query operation with an Authorization, Authentication and Accounting (AAA) server in response to reception of the MCBCS authentication information transmission request message; deriving MCBCS authentication information for the MS according to the result of the MCBCS MS profile information query operation; and transmitting the derived MCBCS authentication information to the MS. The MCBCS MS profile information includes a random seed allocated to at least one MCBCS channel serviceable by the MS.

According to still another aspect of the present invention, there is provided a method for providing a Multicast/Broadcast Service (MCBCS) key by a Mobile Station (MS) in a communication system. The method includes transmitting an MCBCS key request message for requesting transmission of an MCBCS key, to an MCBCS server; and receiving from the MCBCS server an MCBCS key response message in response to transmission of the MCBCS key request message, wherein the MCBCS key response message includes an MCBCS key encrypted using an MCBCS encryption key, a life time of the encrypted MCBCS key, an MS's random seed used for generating the MCBCS encryption key, and a life time of the MS's random seed. The MCBCS key is a key that the MCBCS server has derived using MCBCS MS profile information managed by an Authorization, Authentication and Accounting (AAA) server according to the MCBCS key request message, and the MCBCS MS profile information includes a random seed allocated to at least one MCBCS channel serviceable by the MS.

According to still another aspect of the present invention, there is provided a method for providing a Multicast/Broadcast Service (MCBCS) key in a communication system. The method includes transmitting, by an MCBCS server, information on MCBCS channels for which the MCBCS server intends to derive an MCBCS key, to an Authorization, Authentication and Accounting (AAA) server; and receiving, by the AAA server, the information on the MCBCS channels, and refreshing the MCBCS key using the information on the MCBCS channels until the AAA server receives from the MCBCS server information on changed MCBCS channels.

### BRIEF DESCRIPTION OF THE DRAWINGS

The above and other aspects, features and advantages of the present invention will become more apparent from the following detailed description when taken in conjunction with the accompanying drawings in which:

FIG. 1 is a diagram schematically illustrating a configuration of a Mobile WiMAX communication system according to an embodiment of the present invention;

FIG. 2 is a signaling flow diagram illustrating a process of providing an MCBCS key in a Mobile WiMAX communication system according to an embodiment of the present invention; and

FIG. 3 is a signaling flow diagram illustrating a process of refreshing an MCBCS key in a Mobile WiMAX communication system according to an embodiment of the present invention.

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for clarity and conciseness.

The present invention provides an apparatus and method for providing Multicast/Broadcast Service (MCBCS) authentication information in a communication system, for example, a Mobile Worldwide Interoperability for Microwave Access (Mobile WiMAX) communication system. In particular, the present invention provides an apparatus and method for providing MCBCS authentication information differentiated for each Mobile Station (MS) in a Mobile WiMAX communication system. Although a description of the apparatus and method of the present invention for providing service authentication information will be made herein with reference to the Mobile WiMAX communication system supporting the MCBCS, by way of example, the same can be applied to other communication systems supporting other services as well as the MCBCS. For convenience, in the following description, the MCBCS authentication information will be referred to as an ‘MCBCS key’.

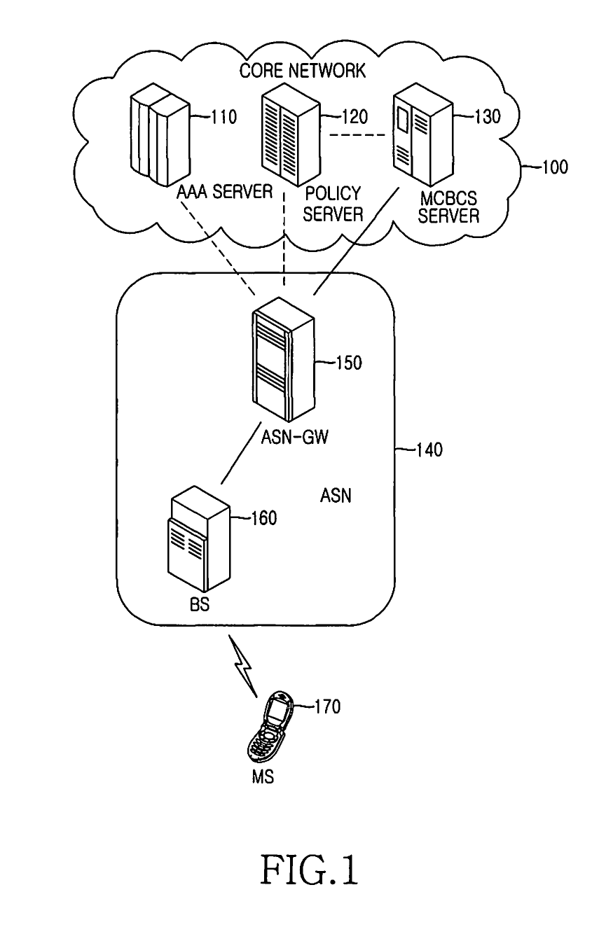

FIG. 1 schematically illustrates a configuration of a Mobile WiMAX communication system according to an embodiment of the present invention.

Referring to FIG. 1, the Mobile WiMAX communication system includes a Core Network (CN) 100, an Access Service Network (ASN) 140, and an MS 170. The ASN 140 is also called a Mobile WiMAX access network. The CN 100 includes an Authorization, Authentication and Accounting (AAA) server 110, a policy server 120, and an MCBCS server 130. The ASN 140 includes an Access Service Network GateWay (ASN-GW) 150, and a Base Station (BS) 160. The ASN-GW 150 can be realized with an Access Control Router (ACR), and the BS 160 can be realized with a Radio Access Station (RAS).

The AAA server 110 manages MS profile information for each of MSs, and the MS profile information includes MCBCS MS profile information of a corresponding MS, a security key, and a life time of the security key. The security key is derived during initial authentication of the corresponding MS. A detailed description of the MCBCS MS profile information will be made below.

The policy server 120 manages Quality-of-Service (QoS) profile information for each Internet Protocol (IP) flow, and upon receiving from the MCBCS server 130 a notification indicating the request for MCBCS by the MS 170, notifies the ASN-GW 150 that MCBCS is triggered to the MS 170, using a preset interface, for example, a Computer Oracle and Password System (COPS) interface. An operation of the policy server 120 is not directly related to the present invention, so a detailed description thereof will be omitted herein for simplicity.

The MCBCS server 130, which can be connected to the policy server 120, transmits an MCBCS signal provided from an external content server (not shown) to the ASN-GW 150, and upon receiving from the ASN-GW 150 a notification indicating the request for MCBCS by the MS 170, notifies receipt of the notification to the policy server 120. The ASN-GW 150 manages connection and mobility of the MS 170, and generates a unique service flow for each of uplink and downlink connections. Upon receiving from the policy server 120 a notification indicating that MCBCS is triggered to the MS 170, the ASN-GW 150 can generate based thereon a service flow for providing MCBCS to the MS 170.

The BS 160, connected to the ASN-GW 150, is connected to the MS 170 wirelessly. That is, the BS 160 provides a connection of a wireless section to the MS 170, and performs scheduling based on Medium Access Control (MAC) QoS information.

Although the ASN 140 includes one ASN-GW (ASN-GW 150) and one BS (BS 160) in the case shown in FIG. 1, the ASN 140 can include multiple ASN-GWs and each of the multiple ASN-GWs can also include multiple BSs.

Although not separately illustrated in FIG. 1, it is contemplated that there is a separate MCBCS Application Server (AS) for each service provider. The MCBCS AS can exist either inside or outside the CN 100. Aside from the AAA server 110, there may exist a separate AAA server for each service provider. In this case, an AS of each service provider is connected to an AAA server of each service provider. Of course, when there is no separate AAA server for each service provider, an AS of each service provider can be connected to the AAA server 110. The AAA server of each service provider can generate an MCBCS encryption key used for encrypting an MCBCS key generated by the AS of each service provider.

The MCBCS AS can use the ASN 140 by means of the MCBCS server 130. In this case, the MCBCS AS can generate a separate MCBCS key for each MCBCS channel, and can encrypt contents of each MCBCS channel and then transmit the results to the MCBCS server 130. Then the MCBCS server 130 transmits the contents of each MCBCS channel, encrypted by the MCBCS AS, to the ASN 140, and the ASN 140 transmits the encrypted contents of each MCBCS channel, received from the MCBCS server 130, to the MS 170.

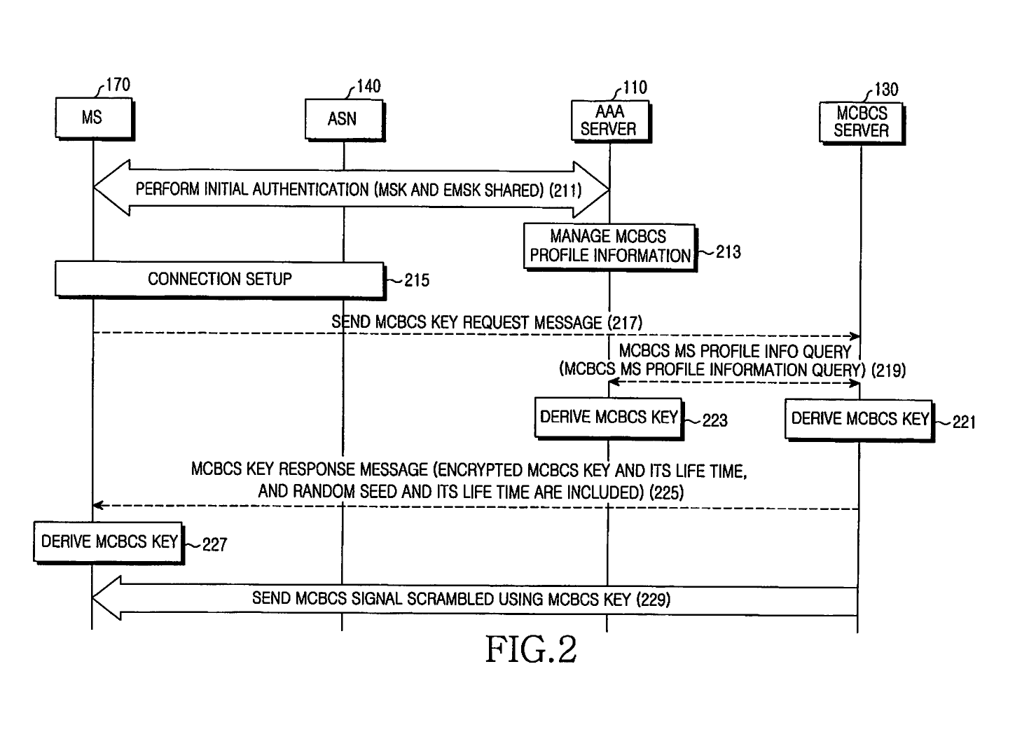

With reference to FIG. 2, a description will now be made of a process of providing an MCBCS key in a Mobile WiMAX communication system according to an embodiment of the present invention.

FIG. 2 is a signaling flow diagram illustrating a process of providing an MCBCS key in a Mobile WiMAX communication system according to an embodiment of the present invention.

Before a description of FIG. 2 is given, it should be noted that there are five possible cases where the MCBCS key provision scheme of the present invention can provide an MCBCS key.

(1) The proposed scheme of the present invention can provide an MCBCS key when an MS periodically requests MCBCS key provision.

Here, the MS can request MCBCS key provision at predetermined intervals, or when a life time of the MCBCS key has expired, the MS can request MCBCS key provision at intervals of the life time.

(2) The proposed scheme of the present invention can provide an MCBCS key when an MS requests MCBCS provision or requests a change in the MCBCS in service.

Here, the phrase ‘requests a change in the MCBCS in service’ indicates that the MS requests MCBCS provision of a channel being different from the channel of the MCBCS that the MS is now being provided with.

(3) The proposed scheme of the present invention can provide an MCBCS key when an MS automatically requests MCBCS key provision upon its initial access.

(4) The proposed scheme of the present invention can provide an MCBCS key when an MS requests MCBCS key provision in response to a request of an AAA server.

(5) The proposed scheme of the present invention can provide an MCBCS key when an MS requests MCBCS key provision in response to a request of an MCBCS server.

The MCBCS key provision process described in FIG. 2 can be applied to all of the foregoing five cases. That is, the MS is provided with an MCBCS key as described in FIG. 2, (i) when the MS periodically requests MCBCS key provision in the state where its connection is set up, (ii) when the MS requests MCBCS provision, or requests a change in the MCBCS inservice, and/or (iii) upon completion of its initial access.

Referring to FIG. 2, an MS 170 and an AAA server 110 perform initial authentication, and as a result of the initial authentication performed, they share a Master Session Key (MSK) and an Extended Master Session Key (EMSK), which are upper key values (Step 211). The initial authentication between the AAA server 110 and the MS 170 can be performed using, for example, an Extensible Authentication Protocol (EAP) scheme, and since an initial authentication operation between the AAA server 110 and the MS 170 is not directly related to the present invention, a detailed description thereof will be omitted herein for simplicity. In addition, the MS 170 and the AAA server 110 can derive a Traffic Encryption Key (TEK) used for encrypting the MAC traffic using the MSK, and since an operation of deriving the TEK using the MSK is not directly related to the present invention, a detailed description thereof will be omitted herein for simplicity.

The AAA server 110 has already stored MCBCS profile information separately for each MS, provisioned by the service provider (Step 213). That is, the AAA server 110 manages MCBCS MS profile information shown in Table 1.

TABLE 1

| | MCBCS | MCBCS | | Remaining |
|---|---|---|---|---|
| User ID | Class | Channel | Random Seed | Lifetime |
| NAI #1 | Gold | 1~10 | xxx | 30 days |
| | | 11~20 | yyy | 30 days |
| | | 21~30 | zzz | 30 days |
| NAI #2 | Silver | 1~10 | xxx | 30 days |
| | | 11~20 | yyy | 30 days |
| | | 21~30 | — | |
| NAI #3 | Bronze | 1~10 | xxx | 30 days |
| | | 11~20 | — | |
| | | 21~30 | — | |
| NAI #4 | None | 1~10 | — | |
| | | 11~20 | — | |
| | | 21~30 | — | |
| . | . | . | . | . |
| . | . | . | . | . |
| . | . | . | . | . |

As shown in Table 1, the AAA server 110 manages MCBCS MS profile information separately for each MS, which includes an MCBCS class, all MCBCS channel indexes provided by the Mobile WiMAX communication system, a random seed allocated to the MCBCS channels, and a life time of the random seed. In Table 1, NAI indicates a Network Access Identifier. The random seed is used for deriving an MCBCS key, and since an operation of deriving the MCBCS key using the random seed is not directly related to the present invention, a detailed description thereof will be omitted herein for simplicity. The life time of the random seed can be, for example, 30 days, and it can be set to an update period of the MCBCS key. Although not separately illustrated in Table 1, the MCBCS MS profile information can include therein an MSK and an EMSK of the corresponding MS.

It will be assumed that the Mobile WiMAX communication system supports four MCBCS classes: Gold class, Silver class, Bronze class, and None class. There are different serviceable MCBCS channels for each of the corresponding MCBCS classes, and the random seed is allocated only to the serviceable MCBCS channels. That is, as shown in Table 1, for the Gold class, all MCBCS channels provided by the Mobile WiMAX communication system, e.g., MCBCS channels 1˜10, MCBCS channels 11˜20, and MCBCS channel 21˜30 are serviceable. Therefore, the random seed is allocated to each of the MCBCS channels 1˜10, MCBCS channels 11˜20, and MCBCS channels 21˜30. In the exemplary case shown in Table 1, a random seed of ‘xxx’ is allocated for the MCBCS channels 1˜10, a random seed of ‘yyy’ is allocated for the MCBCS channels 11˜20, and a random seed of ‘zzz’ is allocated for the MCBCS channels 21˜30.

For the Silver class, not all the MCBCS channels provided by the Mobile WiMAX communication system, but only the MCBCS channels 1˜10 and the MCBCS channels 11˜20 are serviceable. Therefore, the random seed is allocated only for the MCBCS channels 1˜10 and the MCBCS channels 11˜20. As illustrated in Table 1, for Silver class, because the MCBCS channels 21˜30 are unserviceable, no random seed is allocated for the MCBCS channels 21˜30.

For the Bronze class, not all the MCBCS channels provided by the Mobile WiMAX communication system, but only the MCBCS channels 1˜10 are serviceable. Therefore, a random seed is allocated only for the MCBCS channels 1˜10. As shown in Table 1, for the Bronze class, because the MCBCS channels 11˜20 and the MCBCS channels 21˜30 are unserviceable, no random seed is allocated for the MCBCS channels 11˜20 and the MCBCS channels 21˜30.

Finally, for the None class, none of the MCBCS channels provided by the Mobile WiMAX communication system is serviceable. Therefore, a random seed is allocated for none of the MCBCS channels.

Although the MCBCS MS profile information includes indexes of all MCBCS channels provided by the Mobile WiMAX communication system regardless of its MCBCS class in the case shown in Table 1, the MCBCS MS profile information can include indexes of only the serviceable MCBCS channels in its MCBCS class. In Table 1, an MS identifier is denoted as ‘User ID’.

In the state where a connection is set up between the MS 170 and an ASN 140 (Step 215) after the initial authentication is performed between the MS 170 and the AAA server 110, the MS 170 transmits an MCBCS KEY REQUEST message for requesting transmission of an MCBCS key to the MCBCS server 130 (Step 217). As described above, the MCBCS key transmission request is (i) periodically generated at the request of the MS 170, (ii) automatically generated after the initial access, and/or (iii) generated when the MS 170 requests MCBCS provision or requests a change in the MCBCS inservice. The MCBCS KEY REQUEST message is transmitted using an interface such as, for example, a HyperText Transfer Protocol (HTTP) interface and a Session Initiation Protocol (SIP) interface, although other interfaces as well as the HTTP interface and the SIP interface can also be used. Although the MS 170 directly transmits the MCBCS KEY REQUEST message in the exemplary case of FIG. 2, the MS 170 can transmit the MCBCS KEY REQUEST message either at the request of the AAA server 110, or at the request of the MCBCS server 130.

Upon receiving the MCBCS KEY REQUEST message from the MS 170, the MCBCS server 130 performs an MCBCS MS profile information query operation with the AAA server 110 (MCBCS MS PROFILE INFORMATION QUERY) (Step 219). The expression ‘the MCBCS server 130 performs an MCBCS MS profile information query operation with the AAA server 110’ indicates an operation in which the MCBCS server 130 transmits a request for MCBCS MS profile information query for the MS 170 to the AAA server 110, and the AAA server 110 provides MCBCS MS profile information for the MS 170 to the MCBCS server 130 in response to the request. Upon receiving the request for the MCBCS MS profile information query for the MS 170 from the MCBCS server 130, the AAA server 110 provides the MCBCS server 130 not only with an MS's random seed for the MS 170 and a life time of the MS's random seed, but also with an MCBCS root key and a life time of the MCBCS root key. The MS's random seed is a random seed which is different from the above-described unique random seed of each MCBCS channel, and is a random seed used for deriving the MCBCS root key.

A detailed description of the MCBCS root key will be given below.

The MCBCS root key, a kind of an MCBCS encryption key used for encrypting the MCBCS key, can be uniquely set for each MS. The AAA server 110 derives, as an MCBCS root key, an EMSK shared with the MS 170 through the initial authentication performed with the MS 170, and the MS's random seed, using a preset Key Derivation Function (KDF). The KDF for the MCBCS root key derivation can be expressed as Equation (1).

MCBCS root key=KDF(EMSK,MS's random seed) (1)

As shown in Equation (1), KDF indicates a function for deriving an MCBCS root key using the EMSK and the MS's random seed.

Not only the MCBCS root key but also the MCBCS Key Encryption Key (KEK) derived using the MCBCS root key can be used as an encryption key for the MCBCS key, and for convenience, in the following description, the MCBCS root key is used as an encryption key for the MCBCS key, by way of example. In addition, the MCBCS root key can be used for deriving not only the MCBCS KEK but also other MCBCS sub-keys.

In addition, the KDF that the AAA server 110 uses to derive the MCBCS root key should be equal to the KDF that the MS 170 uses to derive the MCBCS root key.

The MCBCS server 130 derives an MCBCS key using the random seed acquired by performing the MCBCS MS profile information query operation (Step 221). Since the operation in which the MCBCS server 130 derives the MCBCS key using the random seed is not directly related to the present invention, a detailed description thereof will be omitted herein for simplicity. However, the scheme in which the MCBCS server 130 derives an MCBCS key using the random seed should be the same as the scheme in which the AAA server 110 derives an MCBCS key using the random seed. In addition, a life time of the MCBCS key derived by the MCBCS server 130 can be set to be equal to a life time of the random seed used for MCBCS key derivation, or they can be set independently of each other. However, the life time of the MCBCS key, set by the MCBCS server 130, should be equal to the life time of the MCBCS key, set by the AAA server 110.

As the MCBCS server 130 performs the MCBCS MS profile information query operation, the AAA server 110 derives an MCBCS key using the random seed (Step 223). Since the operation in which the AAA server 110 derives an MCBCS key using the random seed is not directly related to the present invention, a detailed description thereof will be omitted herein for simplicity. However, the scheme in which the AAA server 110 derives an MCBCS key using the random seed should be the same as the scheme in which the MCBCS server 130 derives an MCBCS key using the random seed. In addition, a life time of the MCBCS key derived by the AAA server 110 can be set to be equal to a life time of the random seed used for MCBCS key derivation, or they can be set independently of each other. However, the life time of the MCBCS key, set by the AAA server 110, should be equal to the life time of the MCBCS key, set by the MCBCS server 130.

The MCBCS server 130 encrypts the derived MCBCS key using the MCBCS root key for the MS 170, and transmits the encrypted MCBCS key, a life time of the encrypted MCBCS key, the MS's random seed and a life time of the MS's random seed to the MS 170 along with an MCBCS KEY RESPONSE message (Step 225). The MCBCS KEY RESPONSE message is a response message to the MCBCS KEY REQUEST message. Although the MCBCS server 130 transmits the MCBCS key encrypted using the MCBCS root key for the MS 170 along with the MCBCS KEY RESPONSE message in the foregoing exemplary case, the MCBCS server 130 can transmit only the MCBCS key along with the MCBCS KEY RESPONSE message, or can encrypt the MCBCS key using a key other than the MCBCS root key, for example, the MCBCS KEK, and then transmit the encrypted MCBCS key along with the MCBCS KEY RESPONSE message.

Upon receiving the MCBCS KEY RESPONSE message from the MCBCS server 130, the MS 170 decrypts the encrypted MCBCS key included in the MCBCS KEY RESPONSE message using the MCBCS root key derived by the MS 170 itself, to thereby derive an MCBCS key (Step 227).

A detailed description will now be made of an operation in which the MS 170 derives the MCBCS root key.

The MS 170 derives, as an MCBCS root key, the EMSK shared with the AAA server 110 through the initial authentication performed with the AAA server 110, and the MS's random seed received over the MCBCS KEY RESPONSE message, using the preset KDF. The KDF that the MS 170 uses to derive the MCBCS root key should be the same as the KDF that the AAA server 110 uses to derive the MCBCS root key.

Thereafter, the MS 170 can receive the scrambled MCBCS signal using the MCBCS key transmitted by the MCBCS server 130 (Step 229).

A description will now be made of a life time of the MCBCS key, and a life time of the MCBCS root key and the MCBCS TEK.

First, a description will be made of the life time of the MCBCS key.

As to the life time of the MCBCS key, as described above, the AAA server 110 triggers in the time interval where it does not provide MCBCS at stated intervals (for example, at intervals of months when the MCBCS provision service charge is imposed on a pay-per-month basis) not based on the time where the MS 170 requests MCBCS key provision, but based on the absolute time, and notifies the remaining (life) time to the MCBCS server 130. Then the MCBCS server 130 manages the remaining time and notifies the MS 170 of the remaining time.

Second, a description will be made of a life time of the MCBCS root key and the MCBCS TEK.

As to the life time of the MCBCS root key and the MCBCS TEK, the AAA server 110 calculates the remaining MCBCS provisionable time for the MS 170 based on the time where the MS 170 requests MCBCS provision, and notifies the MCBCS server 130 of the calculated time. Then the MCBCS server 130 notifies the MS 170 of the life time of the MCBCS root key and the MCBCS TEK using the MCBCS KEY RESPONSE message. Herein, the AAA server 110 calculates the MCBCS provisionable time left for the MS 170 using the MCBCS provision charge and the MCBCS provision start time requested by the MS 170.

As described above, the life time of the MCBCS key and the life time of the MCBCS root key and the MCBCS TEK are set in different ways, causing the following problems.

First, when the life time of the MCBCS key exceeds the life time of the MCBCS root key and the MCBCS TEK, the service provider providing the MCBCS may lose the time determined by subtracting the life time of the MCBCS root key and the MCBCS TEK from the life time of the MCBCS key.

Second, when the life time of the MCBCS root key and the MCBCS TEK exceeds the life time of the MCBCS key, the service provider may refresh the MCBCS key at least once for the time determined by subtracting the life time of the MCBCS key from the life time of the MCBCS root key and the MCBCS TEK. While the service provider refreshes the MCBCS key in this way, the MS may fail to receive seamless MCBCS contents.

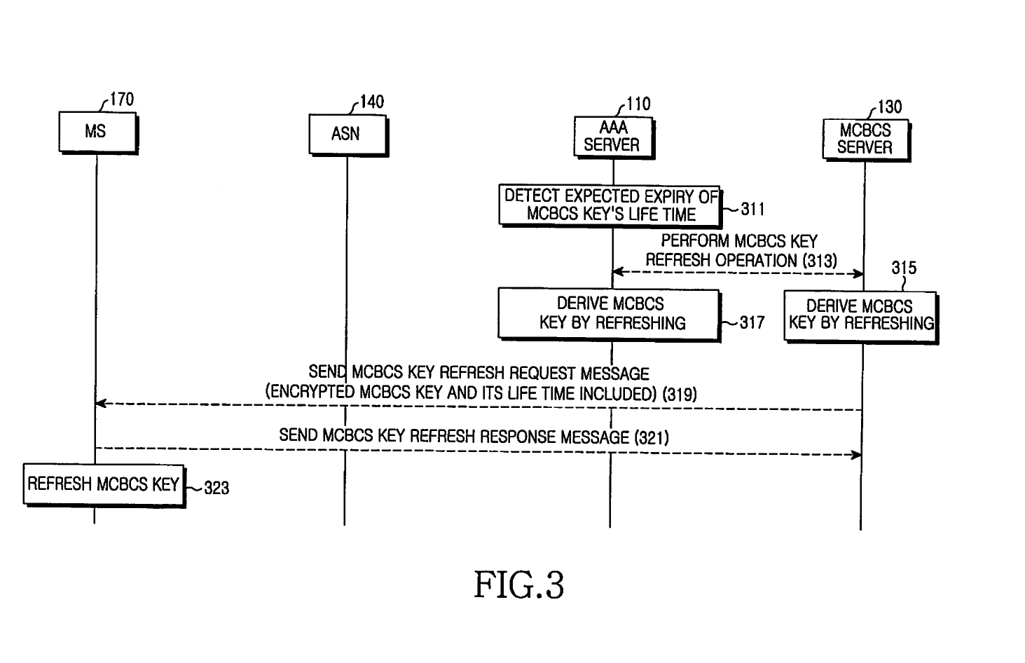

To solve the foregoing problems caused by the difference between the life time of the MCBCS key and the life time of the MCBCS root key and the MCBCS TEK, an embodiment of the present invention refreshes the MCBCS key at intervals of the period shorter than the unit MCBCS provision charge payment period, and provides no MCBCS for the time where it refreshes the MCBCS key. When the refresh of the MCBCS key is performed at intervals that are too short, resource waste may occur due to the frequent signaling performed between the MCBCS server 130 and the AAA server 110. Therefore, the Mobile WiMAX communication system can appropriately adjust the refresh period of the MCBCS key so as to prevent the waste of resources due to the refresh of the MCBCS key. For example, if the MCBCS provision charge payment period is assumed to be one month, the refresh period of the MCBCS key is set to one week, or one day. It is preferable to periodically refresh the MCBCS key because it is very important information during MCBCS provision. The Mobile WiMAX communication system can adaptively determine the refresh period of the MCBCS key according to its system condition, and can set the refresh period taking, for example, the MCBCS billing period into account. With reference to FIG. 3, a description will now be made of an operation of refreshing an MCBCS key in a Mobile WiMAX communication system according to an embodiment of the present invention.

FIG. 3 is a signaling flow diagram illustrating a process of refreshing an MCBCS key in a Mobile WiMAX communication system according to an embodiment of the present invention.

Referring to FIG. 3, when an AAA server 110 detects the expected expiry of a life time of an MCBCS key for an MS 170 from MCBCS MS profile information stored therein (Step 311), the AAA server 110 performs an MCBCS key refresh operation with an MCBCS server 130 to refresh the MCBCS key (Step 313). The MCBCS key refresh operation indicates an operation in which the MS 170 transmits an MCBCS KEY REFRESH OPERATION REQUEST message to the MCBCS server 130 to request execution of a refresh operation on the MCBCS key, and the MCBCS server 130 transmits an MCBCS KEY REFRESH OPERATION RESPONSE message to the MS 170 in response to the MCBCS KEY REFRESH OPERATION REQUEST message to notify the MS 170 that it will perform the refresh operation on the MCBCS key.

As the MCBCS key refresh operation is performed in this manner, the MCBCS server 130 and the AAA server 110 each refresh the old MCBCS key stored therein to derive a new MCBCS key (Steps 315 and 317). For convenience, in the following description, the refreshed newly derived MCBCS key will be referred to as a ‘refreshed MCBCS key’. Since the operation in which the MCBCS server 130 and the AAA server 110 each derive the refreshed MCBCS key is not directly related to the present invention, a detailed description thereof will be omitted herein for simplicity. However, the scheme in which the MCBCS server 130 derives the refreshed MCBCS key should be the same as the scheme in which the AAA server 110 derives the refreshed MCBCS key, and a life time of the refreshed MCBCS key derived by the MCBCS server 130 should also be equal to a life time of the refreshed MCBCS key set by the AAA server 110. In addition, the scheme in which the AAA server 110 derives the refreshed MCBCS key should be the same as the scheme in which the MCBCS server 130 derives the refreshed MCBCS key, and a life time of the refreshed MCBCS key derived by the AAA server 110 should also be equal to a life time of the refreshed MCBCS key set by the MCBCS server 130.

The MCBCS server 130 transmits an MCBCS KEY REFRESH REQUEST message to the MS 170 (Step 319). Herein, the MCBCS server 130 encrypts the refreshed MCBCS key using an MCBCS root key for the MS 170, and includes the encrypted refreshed MCBCS key and a life time of the encrypted refreshed MCBCS key in the MCBCS KEY REFRESH REQUEST message.

Upon receiving the MCBCS KEY REFRESH REQUEST message from the MCBCS server 130, the MS 170 transmits an MCBCS KEY REFRESH RESPONSE message to the MCBCS server 130 in response to the MCBCS KEY REFRESH REQUEST message (Step 321). Further, the MS 170 decrypts the encrypted refreshed MCBCS key included in the MCBCS KEY REFRESH REQUEST message using the MCBCS root key to derive the refreshed MCBCS key. Therefore, the MS 170 refreshes the old MCBCS key stored therein using the derived refreshed MCBCS key (Step 323).

In FIG. 3, the description has been made of the operation in which the AAA server 110 detects a life time of the MCBCS key and refreshes the MCBCS key depending thereon.

Unlike this, however, in order for the MS 170 to refresh the MCBCS key in response to a refresh request for the MCBCS key from the MCBCS server 130, the MCBCS server 130 should have information indicating in which cell the MS 170 is located at the corresponding time. If the MCBCS server 130 does not have the information indicating in which cell the MS 170 is now located, the MCBCS server 130 cannot transmit the MCBCS KEY REFRESH REQUEST message to the MS 170, and the MS 170, as it receives no MCBCS KEY REFRESH REQUEST message, will have the old MCBCS key, making the MCBCS key refresh impossible. Therefore, as described in FIG. 2, it can be preferable that the MS 170 periodically requests MCBCS key transmission to perform MCBCS key refresh.

In FIG. 3, the description has been made of the operation of refreshing the MCBCS key according to the life time of the MCBCS key regardless of the change in the MCBCS channel information. However, the AAA server 110 can periodically triggers regardless of the life time of the MCBCS key and transmit an MS's random seed to the MCBCS server 130 so that the MCBCS server 130 may refresh the MCBCS key. Herein, the change in the MCBCS channel information includes all of (i) the change in information on the MCBCS channel, (ii) the addition of a new MCBCS channel(s), and (iii) the presence of any MCBCS channel deleted from the old MCBCS channels.

One of the following two schemes can be used for allowing the MCBCS server 130 to refresh the MCBCS key by means of the periodic triggering made by the AAA server 110.

A first scheme will be described below.

The MCBCS server 130 transmits once the information on all MCBCS channels for which it desires to derive the MCBCS key, to the AAA server 110. Herein, the MCBCS server 130 stores the information on all MCBCS channels that it transmitted to the AAA server 110. Thereafter, when there is a change in the information on at least one of all the MCBCS channels for which it desires to derive the MCBCS key, the MCBCS server 130 transmits information on all the MCBCS channels to the AAA server 110, and stores the corresponding information. Although the MCBCS server 130 transmits the information on all the MCBCS channels to the AAA server 110 in the foregoing case, the MCBCS server 130 can transmit information on only the MCBCS channel whose information is changed, rather than all MCBCS channels, and store the corresponding information.

A second scheme will be described below.

The AAA server 110 does not separately manage MCBCS channel information, and every time the AAA server 110 periodically triggers, it allows the MCBCS server 130 to transmit to the AAA server 110 the information on all the MCBCS channels for which it desires to derive the MCBCS key.

A description will now be made of the time where the MCBCS server 130 transmits the MCBCS channel information to the AAA server 110 in the first scheme.

First, every time the information on the MCBCS channel is changed, the MCBCS server 130 transmits the changed information on the MCBCS channel to the AAA server 110 regardless of the MCBCS key refresh period triggered by the AAA server 110, and updates MCBCS channel information of the MCBCS server 130 itself. That is, the time where the MCBCS server 130 transmits the MCBCS channel information to the AAA server 110 is the time where the information on the MCBCS channel is changed. In this case, the AAA server 110 can transmit a random seed to the MCBCS server 130 so that the MCBCS server 130 may derive a new MCBCS key immediately for the MCBCS channel having the changed information, or can transmit a random seed for all MCBCS channels to the MCBCS server 130 at the next MCBCS key refresh time.

Second, the invention adds a procedure in which the AAA server 110, when periodically triggers, can determine whether there is any change in the MCBCS channel information between the AAA server 110 and the MCBCS server 130. That is, the AAA server 110, when periodically triggers, queries the MCBCS server 130 whether there is any change in the MCBCS channel information. Then the MCBCS server 130 notifies the presence/absence of the change in the MCBCS channel information to the AAA server 110 according to the determination on the presence/absence of the change in the MCBCS channel information of the AAA server 110.

The MCBCS channel described in the present invention can indicate an MCBCS content provider that actually provides MCBCS contents, or can indicate the MCBCS contents provided by the MCBCS content provider, such as news, drama, movie, etc. Similarly, Multi-Cast ID (MCID) or logical channel ID can indicate a broadcasting station or content. Therefore, even the MCBCS Group Traffic Encryption Key (GTEK) or the MCBCS KEK can be generated for the MCBCS channel or MCBCS contents, and in the hierarchical structure, an MCBCS content provider GTEK and an MCBCS content provider KEK can be provided for each MCBCS content provider, and an MCBCS contents GTEK and an MCBCS contents KEK can be provided in the lower layer thereof.

In addition, the MCBCS server described in the present invention can be realized with one network entity, and an Access Service Provider (ASP) and a Broadcast Service Provider (BSP) can be divided into multiple entities in different ways so that they are separated into various software modules for multicast traffic generation, mapping table generation, broadcast schedule generation, and management of encryption key, random seed and life time. In the present invention, the network entities managed by the ASP and the BSP are referred to as a Core Service Network (CSN).

Although the present invention has been described with reference to the exemplary case where the MS requests and receives the encryption key, random seed and life time, the same can be applied even to the case where the MCBCS server interworks with the AAA server according to the refresh period, and provides information on the encryption key, random seed and life time to the corresponding MS. In order to allow the MCBCS server to provide information on the encryption key, random seed and life time to the corresponding MS in association with the AAA server in this way, the CSN should manage location information of the corresponding MS.

In addition, although the present invention periodically provides information on the corresponding encryption key, random seed and life time to the MS according to the MS service class, it can also periodically provide information on the encryption key, random seed and life time. For a particular paid MCBCS channel or paid MCBCS contents, the present invention can provide information on the encryption key, random seed and life time only to the requesting MS so that only the MS which has previously subscribed to the paid MCBCS channel before the start of MCBCS provision can provide the MCBCS.

Although the present invention has been described with reference to an exemplary scheme of providing information on the encryption key, random seed and life time by means of a unicast flow, the embodiment can provide information on the encryption key and its life time to the multicast broadcast flow corresponding to a particular MCID or logical channel ID, and can provide the unique MCBCS root key and MCBCS KEK of each MS separately only to the corresponding MS by means of the unicast flow as done in the previous manner.

As is apparent from the foregoing description, according to the present invention, the Mobile WiMAX communication system provides MCBCS authentication information separately for each MS, thereby enabling MCBCS provision. In particular, the present invention allows each of the entities of the Mobile WiMAX communication system to transmit/receive and refresh the MCBCS key, thereby contributing to reinforcement of the security function during MCBCS provision.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for providing service authentication information by a Mobile Station (MS) in a communication system, the method comprising:
transmitting a Multicast/Broadcast Service (MCBCS) authentication information transmission request message to an MCBCS server; and
receiving MCBCS authentication information from the MCBCS server in response to transmission of the MCBCS authentication information transmission request message;
wherein the MCBCS authentication information is information that the MCBCS server has derived using MCBCS MS profile information managed by an Authorization, Authentication and Accounting (AAA) server according to the MCBCS authentication information transmission request message, and the MCBCS MS profile information includes a random seed allocated to at least one MCBCS channel serviceable by the MS.

2. The method of claim 1, wherein transmitting the MCBCS authentication information transmission request message to the MCBCS server comprises:
transmitting the MCBCS authentication information transmission request message to the MCBCS server at periods.

3. The method of claim 2, wherein the period is set taking an MCBCS provision charge payment period into account.

4. The method of claim 1, wherein transmitting the MCBCS authentication information transmission request message to the MCBCS server comprises:
transmitting the MCBCS authentication information transmission request message to the MCBCS server when requesting provision of the MCBCS.

5. The method of claim 1, wherein transmitting the MCBCS authentication information transmission request message to the MCBCS server comprises:
transmitting the MCBCS authentication information transmission request message to the MCBCS server when requesting a change in the MCBCS in service.

6. The method of claim 1, wherein transmitting the MCBCS authentication information transmission request message to the MCBCS server comprises:
transmitting the MCBCS authentication information transmission request message to the MCBCS server upon completion of an initial access to the AAA server.

7. The method of claim 1, wherein transmitting the MCBCS authentication information transmission request message to the MCBCS server comprises:
upon receiving from the MCBCS server a request message indicating that the MS should transmit the MCBCS authentication information transmission request message, transmitting the MCBCS authentication information transmission request message to the MCBCS server.

8. The method of claim 1, wherein transmitting the MCBCS authentication information transmission request message to the MCBCS server comprises:
upon receiving from the AAA server a request message indicating that the MS should transmit the MCBCS authentication information transmission request message, transmitting the MCBCS authentication information transmission request message to the MCBCS server.

9. The method of claim 1, wherein when the MCBCS authentication information includes a life time, transmitting the MCBCS authentication information transmission request message to the MCBCS server comprises:
transmitting the MCBCS authentication information transmission request message to the MCBCS server after expiration of the life time.

10. The method of claim 1, further comprising:
after receiving the MCBCS authentication information, receiving from the MCBCS server an MCBCS authentication information refresh request message including refreshed MCBCS authentication information obtained by refreshing the MCBCS authentication information; and
refreshing previously stored MCBCS authentication information using the refreshed MCBCS authentication information.

11. The method of claim 1, wherein the MCBCS MS profile information includes a life time of the random seed.

12. The method of claim 1, wherein the MCBCS authentication information is an MCBCS key, and the MCBCS key is a key generated by applying the random seed to an MCBCS key generation scheme.

13. The method of claim 12, wherein the MCBCS MS profile information includes an MCBCS class determined according to an MCBCS channel serviceable by the MS among MCBCS channels provisionable in the communication system, and an index of the serviceable MCBCS channel.

14. The method of claim 13, wherein the MCBCS MS profile information includes a life time of the random seed.

15. A method for providing service authentication information by a Multicast/Broadcast Service (MCBCS) server in a communication system, the method comprising:
receiving an MCBCS authentication information transmission request message from a Mobile Station (MS);
performing an MCBCS MS profile information query operation with an Authorization, Authentication and Accounting (AAA) server in response to reception of the MCBCS authentication information transmission request message;
deriving MCBCS authentication information for the MS according to the result of the MCBCS MS profile information query operation; and
transmitting the derived MCBCS authentication information to the MS;
wherein the MCBCS MS profile information includes a random seed allocated to at least one MCBCS channel serviceable by the MS.

16. The method of claim 15, further comprising:
detecting a need that the MS should transmit an MCBCS authentication information transmission request message; and
upon detecting the need that the MS should transmit the MCBCS authentication information transmission request message, transmitting to the MS a request message indicating the need to transmit the MCBCS authentication information transmission request message.

17. The method of claim 15, further comprising:
after transmitting the MCBCS authentication information, detecting a need to refresh the MCBCS authentication information;
upon detecting the need to refresh the MCBCS authentication information, refreshing the MCBCS authentication information and deriving refreshed MCBCS authentication information; and
transmitting an MCBCS authentication information refresh request message including the refreshed MCBCS authentication information to the MS.

18. The method of claim 15, wherein the MCBCS MS profile information includes a life time of the random seed.

19. The method of claim 15, wherein the MCBCS authentication information is an MCBCS key, and the MCBCS key is a key generated by applying the random seed to an MCBCS key generation scheme.

20. The method of claim 19, wherein the MCBCS MS profile information includes an MCBCS class determined according to an MCBCS channel serviceable by the MS among MCBCS channels provisionable in the communication system, and an index of the serviceable MCBCS channel.

21. The method of claim 20, wherein the MCBCS MS profile information includes a life time of the random seed.

22. An apparatus for providing service authentication information in a communication system, the apparatus comprising:
a Mobile Station (MS) for transmitting a Multicast/Broadcast Service (MCBCS) authentication information transmission request message to an MCBCS server, and receiving MCBCS authentication information from the MCBCS server in response to transmission of the MCBCS authentication information transmission request message;
wherein the MCBCS authentication information is information that the MCBCS server has derived using MCBCS MS profile information managed by an Authorization, Authentication and Accounting (AAA) server according to the MCBCS authentication information transmission request message, and the MCBCS MS profile information includes a random seed allocated to at least one MCBCS channel serviceable by the MS.

23. The apparatus of claim 22, wherein the MS transmits the MCBCS authentication information transmission request message to the MCBCS server at periods.

24. The apparatus of claim 23, wherein the period is set taking an MCBCS provision charge payment period into account.

25. The apparatus of claim 22, wherein the MS transmits the MCBCS authentication information transmission request message to the MCBCS server when requesting provision of the MCBCS.

26. The apparatus of claim 22, wherein the MS transmits the MCBCS authentication information transmission request message to the MCBCS server when requesting a change in the MCBCS inservice.

27. The apparatus of claim 22, wherein the MS transmits the MCBCS authentication information transmission request message to the MCBCS server upon completion of an initial access to the AAA server.

28. The apparatus of claim 22, wherein upon receiving from the MCBCS server a request message indicating that the MS should transmit the MCBCS authentication information transmission request message, the MS transmits the MCBCS authentication information transmission request message to the MCBCS server.

29. The apparatus of claim 22, wherein upon receiving from the AAA server a request message indicating that the MS should transmit the MCBCS authentication information transmission request message, the MS transmits the MCBCS authentication information transmission request message to the MCBCS server.

30. The apparatus of claim 22, wherein when the MCBCS authentication information includes a life time, the MS transmits the MCBCS authentication information transmission request message to the MCBCS server after expiration of the life time.

31. The apparatus of claim 22, wherein after receiving the MCBCS authentication information, the MS receives from the MCBCS server an MCBCS authentication information refresh request message including refreshed MCBCS authentication information obtained by refreshing the MCBCS authentication information, and refreshing previously stored MCBCS authentication information using the refreshed MCBCS authentication information.

32. The apparatus of claim 22, wherein the MCBCS MS profile information includes a life time of the random seed.

33. The apparatus of claim 22, wherein the MCBCS authentication information is an MCBCS key, and the MCBCS key is a key generated by applying the random seed to an MCBCS key generation scheme.

34. The apparatus of claim 33, wherein the MCBCS MS profile information includes an MCBCS class determined according to an MCBCS channel serviceable by the MS among MCBCS channels provisionable in the communication system, and an index of the serviceable MCBCS channel.

35. The apparatus of claim 34, wherein the MCBCS MS profile information includes a life time of the random seed.

36. An apparatus for providing service authentication information in a communication system, the apparatus comprising:
a Multicast/Broadcast Service (MCBCS) server for receiving an MCBCS authentication information transmission request message from a Mobile Station (MS), performing an MCBCS MS profile information query operation with an Authorization, Authentication and Accounting (AAA) server in response to reception of the MCBCS authentication information transmission request message, deriving MCBCS authentication information for the MS according to the result of the MCBCS MS profile information query operation, and transmitting the derived MCBCS authentication information to the MS;
wherein the MCBCS MS profile information includes a random seed allocated to at least one MCBCS channel serviceable by the MS.

37. The apparatus of claim 36, wherein the MCBCS server detects a need that the MS should transmit an MCBCS authentication information transmission request message, and upon detecting the need that the MS should transmit the MCBCS authentication information transmission request message, transmits to the MS a request message indicating the need to transmit the MCBCS authentication information transmission request message.

38. The apparatus of claim 36, wherein the MCBCS server:
after transmitting the MCBCS authentication information, detects a need to refresh the MCBCS authentication information;
upon detecting the need to refresh the MCBCS authentication information, refreshes the MCBCS authentication information and derives refreshed MCBCS authentication information; and
transmits an MCBCS authentication information refresh request message including the refreshed MCBCS authentication information to the MS.

39. The apparatus of claim 36, wherein the MCBCS MS profile information includes a life time of the random seed.

40. The apparatus of claim 36, wherein the MCBCS authentication information is an MCBCS key, and the MCBCS key is a key generated by applying the random seed to an MCBCS key generation scheme.

41. The apparatus of claim 40, wherein the MCBCS MS profile information includes an MCBCS class determined according to an MCBCS channel serviceable by the MS among MCBCS channels provisionable in the communication system, and an index of the serviceable MCBCS channel.

42. The apparatus of claim 41, wherein the MCBCS MS profile information includes a life time of the random seed.

43. A method for providing a Multicast/Broadcast Service (MCBCS) key by a Mobile Station (MS) in a communication system, the method comprising:
transmitting an MCBCS key request message for requesting transmission of an MCBCS key, to an MCBCS server; and
receiving from the MCBCS server an MCBCS key response message in response to transmission of the MCBCS key request message, wherein the MCBCS key response message includes an MCBCS key encrypted using an MCBCS encryption key, a life time of the encrypted MCBCS key, an MS's random seed used for generating the MCBCS encryption key, and a life time of the MS's random seed;
wherein the MCBCS key is a key that the MCBCS server has derived using MCBCS MS profile information managed by Authorization, Authentication and Accounting (AAA) server according to the MCBCS key request message, and the MCBCS MS profile information includes a random seed allocated to at least one MCBCS channel serviceable by the MS.

44. The method of claim 43, wherein the MCBCS encryption key is a key that the AAA server has generated by applying a preset key derivation function to an Extended Master Session Key (EMSK) shared with the MS through initial authentication performed with the MS, and the MS's random seed.

45. The method of claim 44, further comprising:
after receiving the MCBCS key response message, generating the MCBCS encryption key by applying the key derivation function to an EMSK shared with the AAA server through initial authentication performed with the AAA server, and MS's random seed.

46. The method of claim 45, wherein a life time of the encrypted MCBCS key and a life time of the MS's random seed are determined by the AAA server, the life time of the encrypted MCBCS key indicates a time where the encrypted MCBCS key is valid, and the life time of the MS's random seed indicates a time where MCBCS provision is available for the MS based on a time where the MS has transmitted the MCBCS key request message.

47. The method of claim 46, further comprising:
after receiving the MCBCS key response message, receiving from the MCBCS server an MCBCS key refresh request message including a refreshed MCBCS key obtained by refreshing the MCBCS key, a refreshed MCBCS key encrypted using the MCBCS encryption key, and a life time of the encrypted refreshed MCBCS key; and
deriving the refreshed MCBCS key by decrypting the encrypted refreshed MCBCS key using the MCBCS encryption key, and refreshing the MCBCS key into the refreshed MCBCS key.

48. The method of claim 47, wherein the refreshed MCBCS key is derived taking an MCBCS provision charge payment period into account.

49. A method for providing a Multicast/Broadcast Service (MCBCS) key in a communication system, the method comprising:
transmitting, by an MCBCS server, information on MCBCS channels for which the MCBCS server intends to derive an MCBCS key, to an Authorization, Authentication and Accounting (AAA) server; and
receiving, by the AAA server, the information on the MCBCS channels, and refreshing the MCBCS key using the information on the MCBCS channels until the AAA server receives from the MCBCS server information on changed MCBCS channels.

50. The method of claim 49, further comprising:
upon detecting a change in the information on the MCBCS channels, transmitting, by the MCBCS server, the information on the changed MCBCS channels to the AAA server; and
refreshing, by the AAA server, the MCBCS key using the information on the changed MCBCS channels.

51. The method of claim 50, wherein transmitting the information on the changed MCBCS channels to the AAA server comprises:
transmitting information on only the changed MCBCS channel to the AAA server.

52. The method of claim 50, wherein transmitting the information on the changed MCBCS channels to the AAA server comprises:
transmitting both of information on a changed MCBCS channel and information on an unchanged MCBCS channel, to the AAA server.
